(19) United States
(12) Patent Application Publication
(10) Pub. No.: US 2020/0080365 A1
(43) Pub. Date: Mar. 12, 2020

(54) DOOR GUARD

(71) Applicant: DEBORAH K. DIXON, BAY CITY, MI (US)

(72) Inventor: DEBORAH K. DIXON, BAY CITY, MI (US)

(21) Appl. No.: 16/126,152

(22) Filed: Sep. 10, 2018

(51) Int. Cl. E06B 9/02

(52) U.S. Cl. CPC E06B 9/02; E06B 2009/002

(57) ABSTRACT

A door guard that prevents the passage of persons from one area to another is disclosed and described herein.

### BACKGROUND OF THE INVENTION

The applicant is unaware of any prior art in this field of invention.

### THE INVENTION

The present invention is a door guard. This door guard comprises a first flat sheet of fabric and a second flat sheet of fabric. Each flat sheet is essentially the same size. The two sheets are aligned such that the first flat sheet essentially overlies the second flat sheet. The flat sheets are attached to each other at their respective perimeters.

The combination of the flat sheets has four corners and at least two of the corners of the flat sheets have embedded therein, one-half of a snap fastener.

Each of the flat sheets has an area dimension of up to seventy-two inches long and at least twenty-four inches wide.

The door guard is attached to a doorway to prevent the passage of persons, such as a patient or child, from one area to another. The barrier presents a physical barrier that when encountered discourages passage through the doorway.

What is disclosed is a door guard comprising two flat sheets that have a fire proof filler therebetween and that fire proof filler is based on California technical bulletin #117, Section E.

The door guard may be fabricated from vinyl, rubber, or leather, for example.

### BRIEF DESCRIPTION OF THE DRAWINGS

FIG. 1 is a full front view of the door guard.

FIG. 2 is a full back view of the first sheet of the door guard.

FIG. 3 is a full front view of the second sheet of the door guard.

FIG. 4 is a full back view of the second flat sheet of the door guard.

FIG. 5 is a full end view of the door guard.

FIG. 6 is a full end view of the door guard from the end with the flame retardant material in between.

### DETAILED DESCRIPTION OF THE DRAWINGS

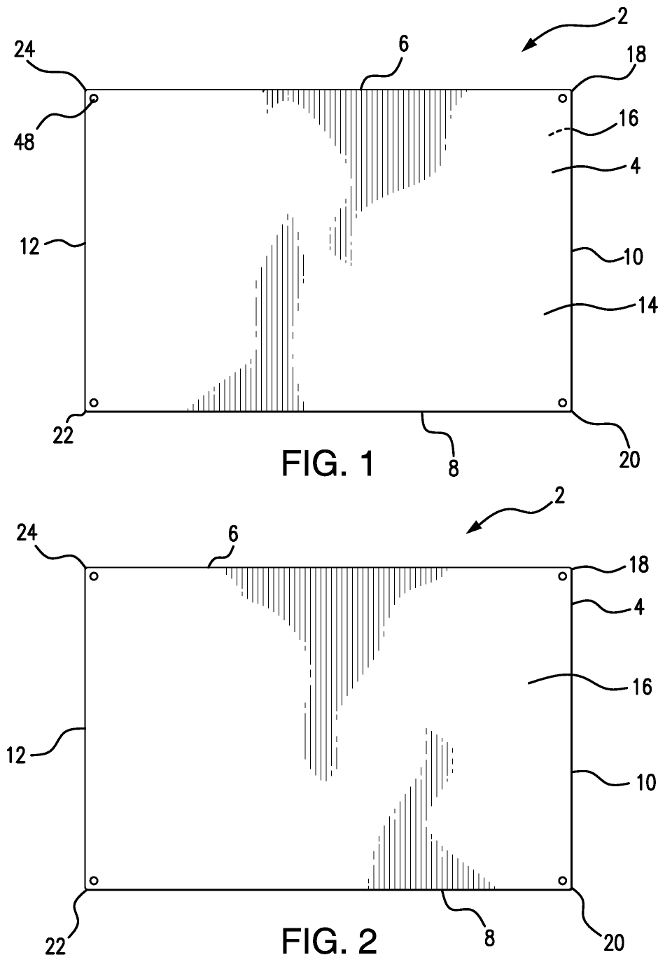

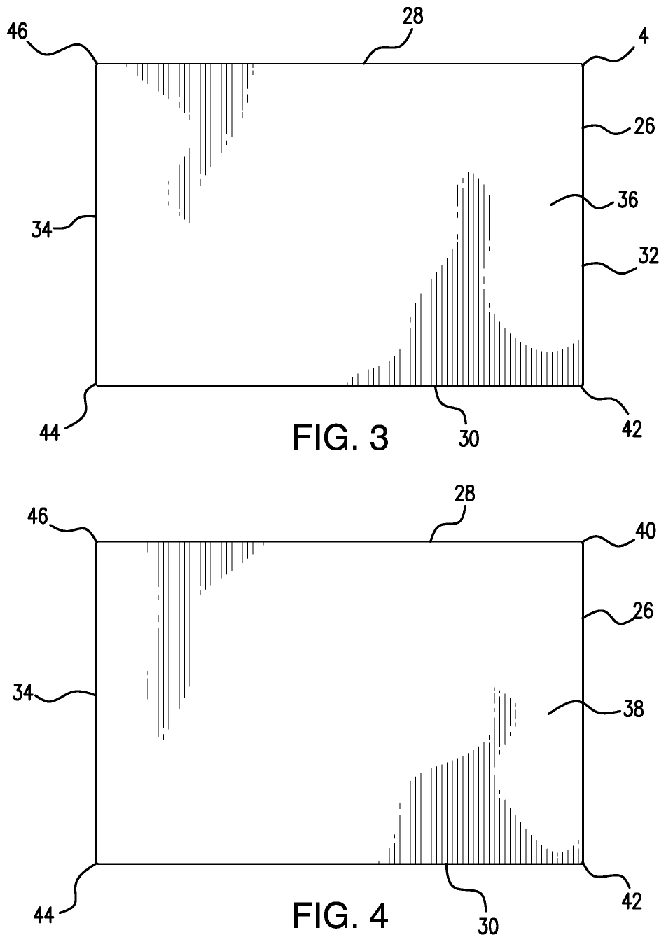

FIG. 1 shows the door guard 2 from the front 14. The door guard 2 is composite of a first flat sheet 4 and a second flat sheet 26 (FIG. 3). This first flat sheet 4 has a top edge 6. The first flat sheet 4 also has a bottom edge 8. The first flat sheet 4 has a first side edge 10 and a second side edge 12. The first flat sheet 4 has a front surface 14 and a rear surface 16 (FIG. 2). The first flat sheet 4 has a first corner 18, a second corner 20, a third corner 22 and a fourth corner 24. The first flat sheet 4 also has a portion of a snap fastener 48 attached near each of the corners 18, 20, 22 and 24.

FIG. 2 shows the first sheet 4 of the door guard 2 from the back 16. This first flat sheet 4 has a top edge 6. The flat sheet 4 also has a bottom edge 8. The first flat sheet 4 has a first side edge 10 and a second side edge 12.

The first flat sheet 4 has a rear surface 14. The first flat sheet 4 has a first corner 18, a second corner 20, a third corner 22 and a fourth corner 24. The first flat sheet 4 also has a portion of a snap fastener 48 attached near each of the corners 18, 20, 22 and 24.

FIG. 3 shows the second sheet 26 of the door guard 2 from the front 36. The second flat sheet 26 has a top edge 28. The second flat sheet 26 also has a bottom edge 30. This second flat sheet 26 has a first side edge 32 and a second side edge 34. The second flat sheet 26 also has a front surface 36.

FIG. 4 shows the second flat sheet 26 of the door guard 2 from the rear 38. The second flat sheet 26 has a top edge 28. The second flat sheet 26 also has a bottom edge 30. This second flat sheet 26 has a first side edge 32 and a second side edge 34. The second flat sheet 26 also has a front surface 36.

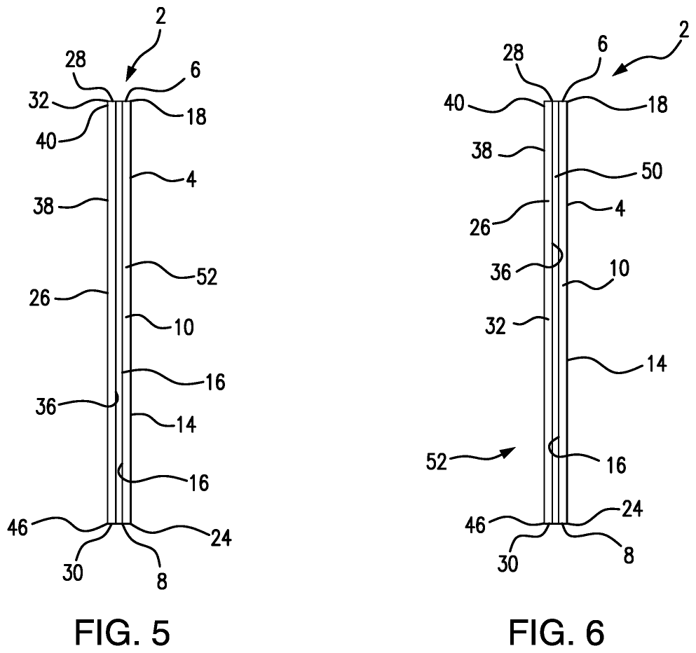

FIG. 5 shows the door guard 2 from the end 52. Here the first flat sheet 4 and the second flat sheet 26 are combined to form the door guard 2. The first flat sheet 4 has a top edge 6 and a bottom edge 8. Also present is the side edge 10. Also present is the front surface 14 and the rear surface 16. Also shown is the first corner 18 and the fourth corner 24.

The second flat sheet 26 has a bottom edge 30 and a fourth corner 46. Also shown is the front surface 36 of the second flat sheet 26. The rear sheet 38 of the second flat sheet 26 is also clearly shown. The first corner 40 of the second flat sheet 26 is shown with the top edge 28 and the first side edge 32.

FIG. 6 shows the door guard 2 from the end 52 with the flame retardant material 50 in between the first flat sheet 4 and the second flat sheet 26. The first flat sheet 4 has a first corner 18, a second corner 20, a third corner 22 and a fourth corner 24. The first flat sheet 4 also has a portion of a snap fastener 48 attached near each of the corners 18, 20, 22 and 24. The second flat sheet 26 has a first corner 40, a second corner 42, a third corner 44 and a fourth corner 46.

The first flat sheet 4 also has a portion of a snap fastener 48 attached near each of the corners 18, 20, 22 and 24. The second flat sheet 26 also has a portion of a snap fastener 48 attached near each of the corners 40, 42, 44 and 46. The portions of the snap fasteners 48 from the first flat sheet 4 and the second flat sheet 26 combine to form snap fasteners to attach the door guard to a doorway to prevent the passage of people through the doorway.

What is claimed is:

1. A door guard, said door guard comprising:
a. a first flat sheet of fabric and a second flat sheet of fabric, each having essentially the same size, said two sheets aligned such that said first flat sheet essentially overlies said second flat sheet, said flat sheets being attached to each other at their respective perimeters;
b. said combination of said flat sheets having four corners and at least two said corners of said flat sheets having embedded therein, one-half of a snap fastener;
c. each said flat sheet having an area dimension of up to seventy-two inches long and at least 24 inches wide;
d. said flat sheets having flame retardancy based on California technical bulletin #117, Section E.

2. A door guard as claimed in claim 1 wherein the fabric is vinyl.

3. A door guard as claimed in claim 1 wherein the fabric is rubber.

4. A door guard as claimed in claim 1 wherein the fabric is leather.
